(19) United States
(12) Patent Application Publication
(10) Pub. No.: US 2003/0216948 A1
(43) Pub. Date: Nov. 20, 2003

(54) Method and program for processing seat reservation cancellations

(75) Inventor: Yuunosuke Ishinabe, Inagi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/345,949

(22) Filed: Jan. 17, 2003

(30) Foreign Application Priority Data
May 17, 2002 (JP) 2002-142304

(51) Int. Cl. G06F 17/60

(52) U.S. Cl. 705/5

(57) ABSTRACT

A method for seat reservation cancellation in a server that receives seat reservation applications including each number of seat from the first desired seat to the n-th desired seat (n is an integer not less than 2) comprises the step of, if any seat reservation cancellation occurs, comparing each number of seat from the first desired seat to the n-th desired seat in the seat reservation application with the number of seat of the canceled seat sequentially in order of receipt of the seat reservation applications, and then, if any seat reservation application wherein both numbers of seats match with each other is detected, assigning the number of seat of the canceled seat to the seat reservation application, whereby the method and a program for processing seat reservation cancellations that implement seat reservation in a so-called “first come, first served” manner so that, in other words, those who make seat reservations earlier can get more satisfactory seats, are provided.

### BACKGROUND OF THE INVENTION

1. Field of the Invention

The present invention relates to a method and a program for processing seat reservation cancellations and, in particular, it relates to a method and a program, for processing seat reservation cancellations, that are intended for processing cancellations when reserved seats are canceled in places where seats that may be subject to reservation are provided, such as concert halls, baseball stadiums, soccer stadiums, passenger trains, airplanes, university lectures and the like.

2. Description of the Related Art

Those who wish to go to a concert or take an airplane need to secure seats that are provided in the concert hall or in the airplane, respectively.

Conventionally, those who wish to secure seats in the concert hall or in the airplane (hereinafter referred to as the “applicant”) first make a telephone call to a business entity that sells tickets for the concert or tickets for the airplane.

When making the telephone call, the applicant notifies the business entity of information about the seat he or she desires, such as “a front row seat on the first floor” or “a window seat”, along with his or her name, a telephone number and other information.

Upon receiving such notification, the business entity makes a reservation for the seat that the applicant desires.

Then, the applicant later goes to the business entity to receive the ticket or the air ticket for the reserved seat in exchange, for example, for money.

Conventionally, an applicant has secured a seat according to such a system.

However, in such conventional system, it is irrevocably settled which seat is reserved for the applicant at the time when the reservation is taken, in other words, at the time when the applicant makes the telephone call.

Therefore, in the conventional system, there is a problem in that, after a later applicant reserves a seat by calling the business entity, if an earlier applicant cancels a seat reservation, a third applicant, who calls the business entity for seat reservation after the cancellation by the earlier applicant and after the reservation by the above-mentioned later applicant, may secure a better seat than the later applicant.

### SUMMARY OF THE INVENTION

Therefore, in view of the above problem, it is an object of the present invention to provide a method and a program, for processing seat reservation cancellations, that implement seat reservation in a so-called “first come, first served” manner so that, in other words, those who make seat reservations earlier get more satisfactory seats.

According to the present invention, the above problem can be solved using means as set forth in the appended claims.

More specifically, according to a first aspect of the present invention, there is provided a method for processing seat reservation cancellations in a server that receives seat reservation applications including each number of seat for the first desired seat to the nth desired seat (n is an integer not less than 2).

A seat reservation application is sent by an applicant who wishes to secure a seat in any place of meeting such as a concert hall or an airplane from a terminal to the server via a network.

Upon receiving the seat reservation application, the server takes a reservation for the seat desired by the applicant who sends this application. If any seat reservation cancellation occurs, the server compares each number of seat from the first desired seat to the n-th desired seat in said seat reservation application with the number of seat of such canceled seat.

As a result of the comparison, if both numbers match with each other, the server assigns the number of seat of the canceled seat to the seat reservation application. The server performs such comparison and assignment process sequentially in order of receipt of said seat reservation application.

More specifically, the server compares each number of seat from the first desired seat to the n-th desired seat requested by a later applicant with the number of seat canceled by an earlier applicant and, then, if it is determined that each number of seat from the first desired seat to the n-th desired seat of the later application does not include the number of seat canceled by an earlier applicant, the server continues a comparison and assignment process for each number of seat from the first desired seat to the n-th desired number of seat requested by a third applicant who calls the business entity for seat reservation after the cancellation by the earlier applicant and after the reservation by the later applicant, just as in the case of the above-mentioned later application.

Thus, the comparison and assignment process, for each number of seat from the first desired seat to the n-th desired seat, of the subsequent application is performed after the comparison and assignment process for each number of seat from the first desired number of seat to the n-th desired number of seat of the previous application is completed.

Further, according to a second aspect of the present invention, there is provided a program for allowing a server that receives seat reservation applications including each number of seat from the first desired seat to the n-th desired seat (n is an integer not less than 2) to execute the following step.

More specifically, if any seat reservation cancellation occurs, the program allows the server to execute the step of comparing each number of seat from the first desired seat to the n-th desired seat in said seat reservation application with the number of seat of such canceled seat and, then, if any seat reservation application wherein both numbers of seats match with each other is detected, assigning the number of seat of such canceled seat to the seat reservation application. This comparison and assignment process is performed sequentially in order of receipt of said seat reservation application.

Further, according to a third aspect of the present invention, there is provided a method for processing seat reservation cancellations in a server that receives seat reservation applications including numbers of areas in which seats are disposed from the first desired area to the n-th desired area (n is an integer not less than 2).

The server that executes the method for processing cancellations according to claim 3 differs from the server that executes the method for processing cancellations according to claim 1 in that it receives seat reservation applications including each area number from the first desired area to the n-th desired area. Here, the area represents a region in which seats are disposed.

Thus, according to the third aspect, the applicant can specify the desired seat in a manner such as, for example, “a front row on the first floor” in a concert hall, “an infield stand” in a baseball stadium, or “a window seat” in an airplane.

If any seat reservation cancellation occurs, the server compares each number of seat of a plurality of seats disposed in each area from the first desired area to the n-th desired area in said seat reservation application with the number of seat of such canceled seat and, then, if any seat reservation application wherein both numbers of seats match with each other is detected, the server assigns the number of seat of such canceled seat to the seat reservation application. This comparison and assignment process is performed sequentially in order of receipt of said seat reservation application.

Further, according to a fourth aspect of the present invention, there is provided a program for allowing a server that receives seat reservation applications including numbers of areas in which seats are disposed from the first desired area to the n-th desired area (n is an integer not less than 2) to execute the following step.

More specifically, if any seat reservation cancellation occurs, the program allows the server to execute a step for comparing each number of seat of a plurality of seats disposed in each area from the first desired area to the n-th desired area of said seat reservation application with the number of seat of the canceled seat in order of receipt of said seat reservation application sequentially and, then, if any seat reservation application wherein both numbers match with each other is detected, assigning the number of seat of such canceled seat to the seat reservation application. This comparison and assignment process is performed sequentially in order of receipt of said seat reservation application.

### BRIEF DESCRIPTION OF THE DRAWINGS

FIG. 1 is a flow chart describing seat reservation cancellation process according to an embodiment of the present invention;

FIG. 2 is a diagram showing seat reservation according to an embodiment of the present invention schematically;

FIG. 3 is a diagram showing a seat arrangement table (that is partitioned in advance) on a web page according to an embodiment of the present invention;

FIG. 4 is a diagram describing how an applicant assigns the first to n-th desired areas to a seat arrangement table on a web page according to an embodiment of the present invention;

FIG. 5 is a diagram showing a seat arrangement table (that is partitioned by an applicant) on a web page according to an embodiment of the present invention;

FIG. 6 is a diagram showing a seat arrangement table (to which the first to n-th desired areas of an applicant is assigned) on a web page according to an embodiment of the present invention;

FIG. 7 is a diagram showing a sequence of seat reservations according to an embodiment of the present invention;

FIG. 8 is a flow chart describing seat reservations that is performed by a seat reservation server according to an embodiment of the present invention for seat reservation applications when the seat reservation server receives such seat reservation applications;

FIGS. 9A and 9B are diagrams describing a seat reservation cancellation process according to an embodiment of the present invention;

FIG. 10 is a diagram describing seat confirmation and confirmation notification after a seat reservation by an applicant according to an embodiment of the present invention; and

FIG. 11 is a diagram showing a table that is stored in storage means of a seat reservation server according to an embodiment of the present invention.

### DESCRIPTION OF THE PREFERRED EMBODIMENT

Hereinafter, an embodiment of the present invention will be described with reference to the accompanying drawings.

As shown in FIG. 2, an applicant who wishes to secure an seat in a concert hall or in an airplane checks a seat arrangement table of the concert hall or the airplane, respectively, on a web page on the Internet.

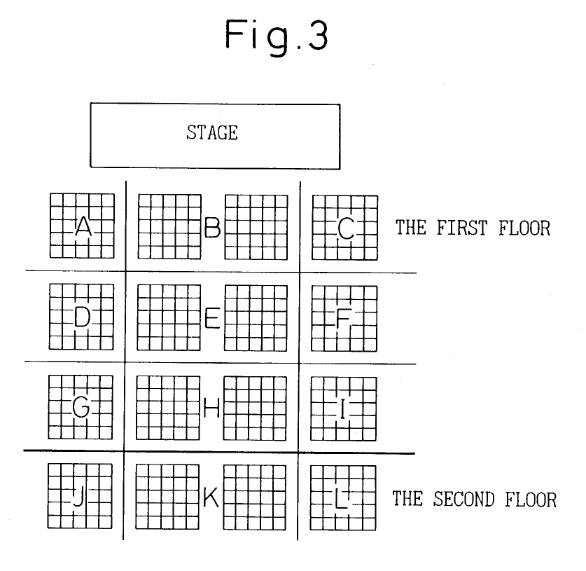

On the web page according to the embodiment, the seat arrangement table as shown in FIG. 3 is displayed. The seat arrangement table on the web page is partitioned into areas from A to L in advance, in each of which 10 seats are disposed.

Though it is assumed that 10 seats are disposed in each area in this embodiment, the number of the seats in each area is not limited to 10 by the present invention. Thus, one,

100, 1000 or any other number of seats may be disposed in each area. If only one seat is disposed in each area, the “area” may be replaced by the “seat” in this embodiment.

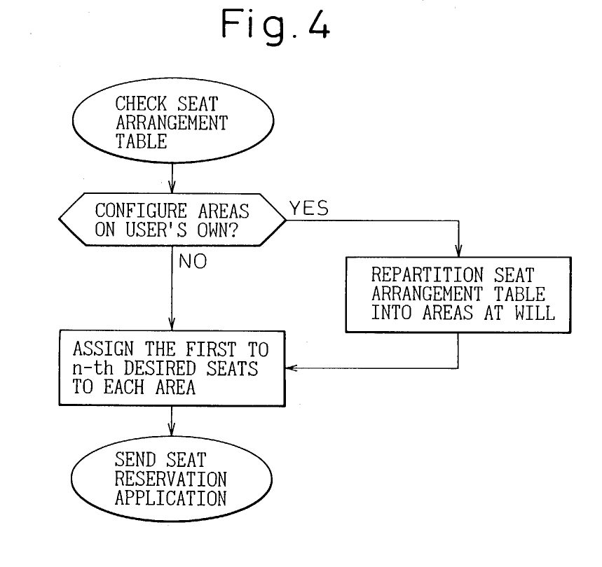

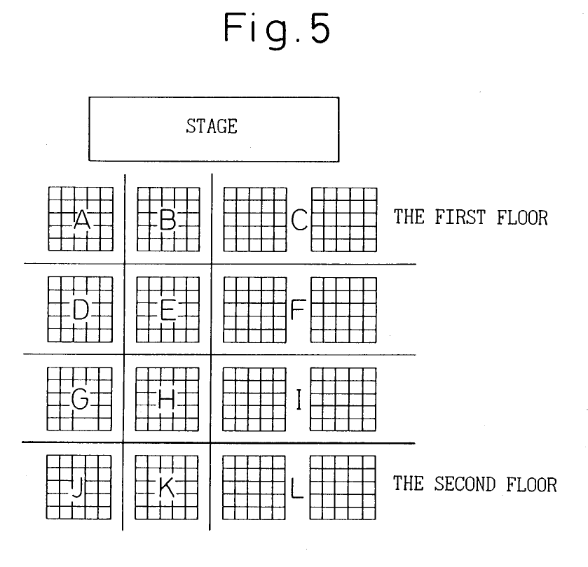

The applicant can repartition the seat arrangement table at will (FIG. 4). Thus, the applicant can repartition the seat arrangement table shown in FIG. 3 into the seat arrangement table shown in FIG. 5, for example.

In this embodiment, it is assumed that the applicant does not repartition the seat arrangement table at will and follows the seat arrangement table that is partitioned in advance as shown in FIG. 3.

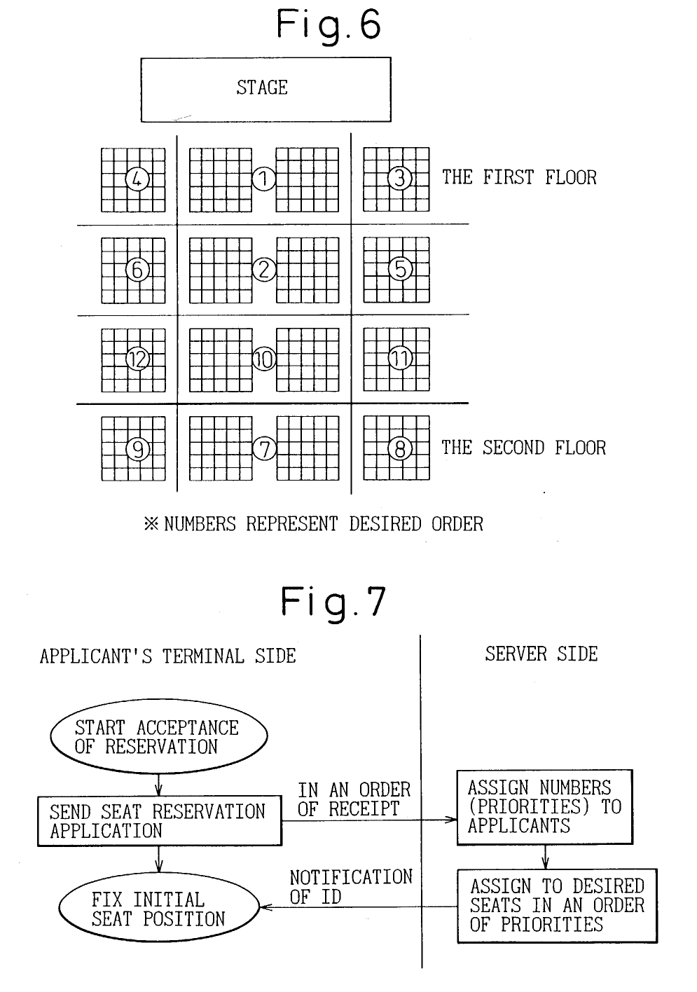

The applicant assigns the first to n-th desired areas (n=12 in this embodiment) to each area shown in FIG. 3 so that the desired areas are disposed as shown in FIG. 6, for example.

The applicant sends the first to n-th desired areas along with data on the applicant's name, telephone number, e-mail address and the like to a seat reservation server via a terminal as seat reservation application (FIG. 4). Here, the applicant may further include data as to the number of seats he or she wishes to secure in the seat reservation application that is sent to the seat reservation server.

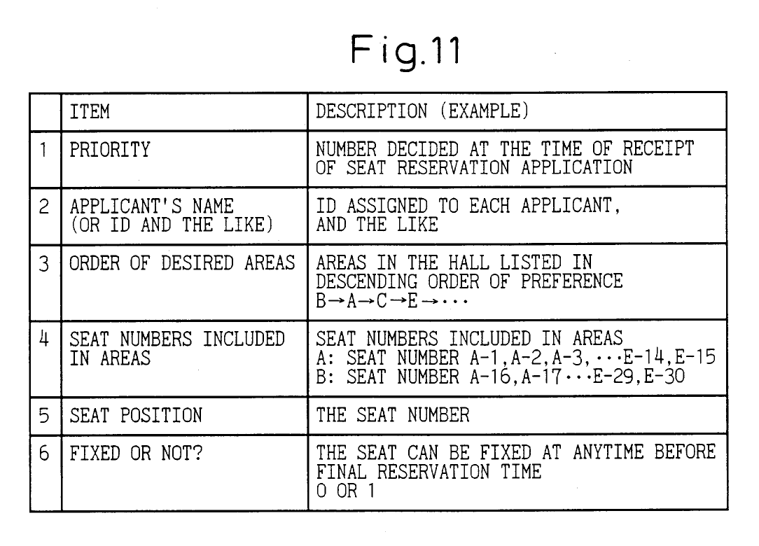

When the seat reservation server receives the seat reservation application, the seat reservation server stores the data as to the applicant's name, the telephone number, the e-mail address, the first to n-th desired areas and the like in a table that is created for every seat reservation application (FIG. 11).

Here, though the table shown in FIG. 11 is stored in storage means such as a hard disk drive or main memory of the seat reservation server in this embodiment, the table may alternatively be stored in storage means of another server that is connected to the seat reservation server via a network.

The seat reservation server assigns priorities to the received seat reservation applications sequentially, or in other words, in order of receipt (FIG. 7). Thus, the seat reservation server assigns higher priorities to seat reservation applications received earlier. After the seat reservation server assigns the priorities to the seat reservation applications, the seat reservation server stores the priorities in the table in FIG. 11.

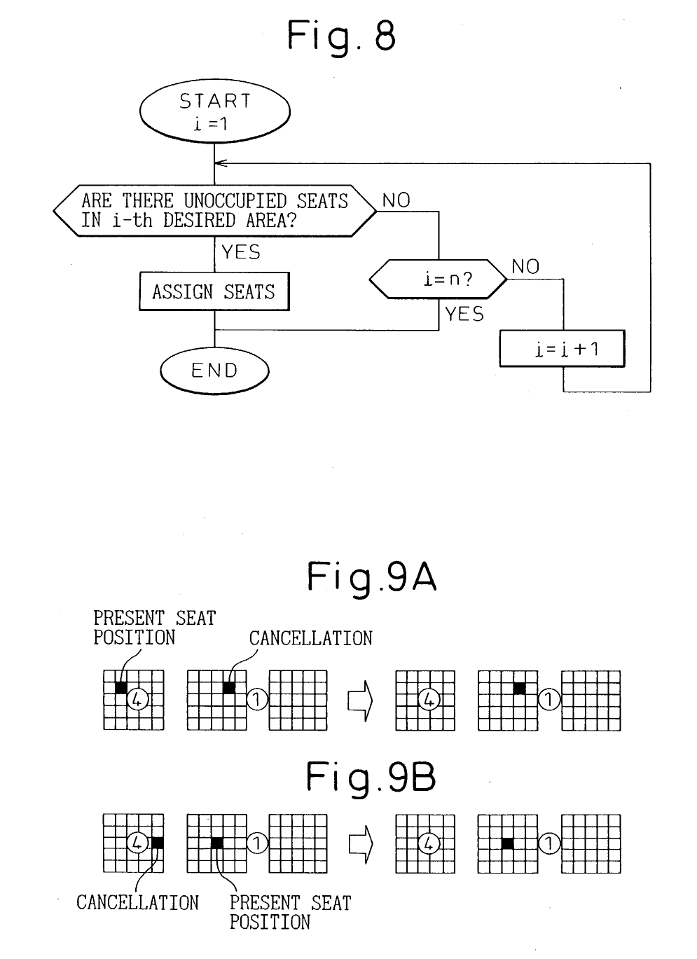

As shown in FIG. 8, the seat reservation server examines whether there are unoccupied seats in the first desired area in the seat reservation application by referencing the table as shown in FIG. 11, and then, if there are unoccupied seats, the seat reservation server assigns the unoccupied seats to such seat reservation application.

On the other hand, if there is no unoccupied seat in the first desired area, the seat reservation server examines whether there are unoccupied seats in the second desired area by referencing the table as shown in FIG. 11, and then, if there are unoccupied seats, the seat reservation server assigns the unoccupied seats to such seat reservation application (FIG. 8).

Thus, the seat reservation server examines whether there are unoccupied seats in the first to n-th desired areas of the received seat reservation application sequentially from the first desired area, and then, if there are unoccupied seats, the seat reservation server assigns the unoccupied seats to such seat reservation application (FIG. 8).

Then, if the seat reservation server cannot detect unoccupied seats even in the n-th desired area in the received seat reservation application, the seat reservation server notifies the applicant of the seat reservation application that there is no unoccupied seat in the desired areas (hereinafter, such notification is referred to as the “desired area occupation notification”). This desired area occupation notification is transferred, for example, by telephone or by e-mail based upon the telephone number or the e-mail address included in the seat reservation application.

Here, even if there is no unoccupied seat in the desired areas in the seat reservation application (in other words, even when the desired area occupation notification is issued), the seat reservation server can maintain the priority described above for such seat reservation application, without deleting the priority from the table as shown in FIG. 11. Therefore, in this case, the seat reservation application concerning the applicant to whom the desired area occupation notification is issued is still subject to seat reservation cancellation process described later. The seat reservation server can include information about the priority in the desired area occupation notification.

After the seat reservation server assigns seats to the seat reservation application as described above, the seat reservation server notifies the applicant who transmitted such seat reservation application of an application ID so that the seat reservation server can identify the applicant. This notification is transferred, for example, by telephone or by e-mail based upon the telephone number or the e-mail address included in the seat reservation application. As described above, the applicant secures an initial seat position.

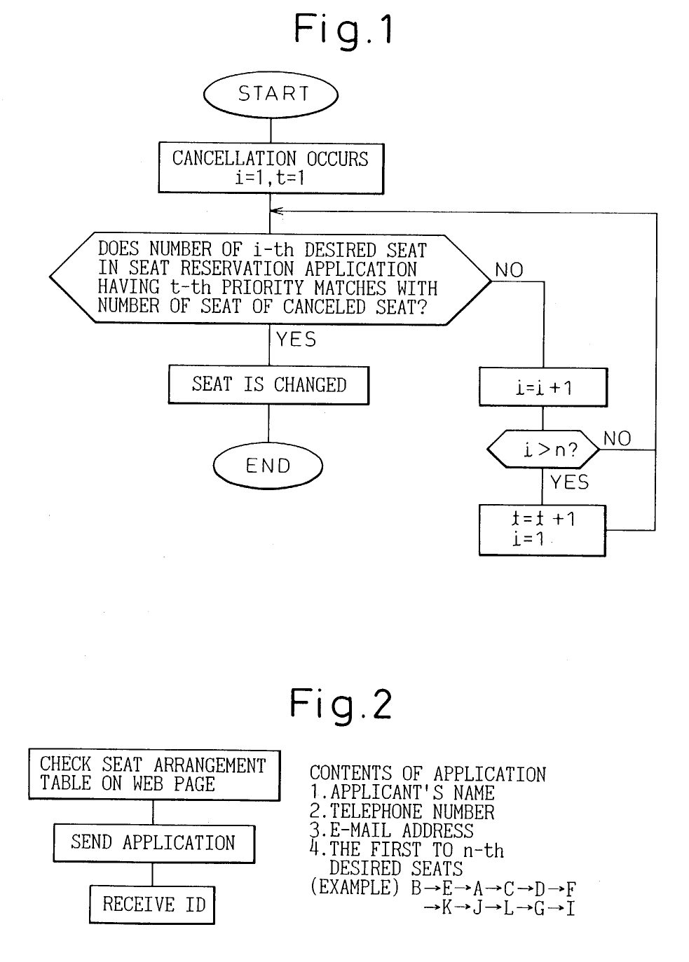

FIGS. 9A and 9B are diagrams describing seat reservation cancellation process according to an embodiment of the present invention, and FIG. 1 is a flow chart describing the seat reservation cancellation process according to an embodiment of the present invention.

As shown in FIG. 1, the seat reservation server performs the seat reservation cancellation process as follows. In particular, when any seat reservation cancellation occurs, the seat reservation server first compares the number of seat of the first desired seats in the seat reservation application having the highest priority to the number of seat of the canceled seats by referencing the table shown in FIG. 11. If these numbers match with each other, the seat reservation server assigns the canceled seats to such seat reservation application (FIG. 9A).

On the other hand, if these numbers do not match with each other, the seat reservation server compares the number of seat of the second desired seats in such seat reservation application having the highest priority to the number of seat of the canceled seats by referencing the table shown in FIG. 11. Also in this case, if these numbers match with each other, the seat reservation server assigns the canceled seats to such seat reservation application (FIG. 9A).

If the numbers for the second desired seats also do not match with each other, the seat reservation server repeats similar process for the third to the n-th desired seats.

Then, if the number of the n-th desired seats of the seat reservation application having the highest priority does not match with the number of the canceled seats, the seat reservation server does not change the seats of the seat reservation application having the highest priority (FIG. 9B), but performs the process described above for the next seat reservation application having the second highest priority.

Thus, the seat reservation server performs the seat reservation cancellation process sequentially from the seat reservation application having the highest priority to the seat reservation application having the lowest priority.

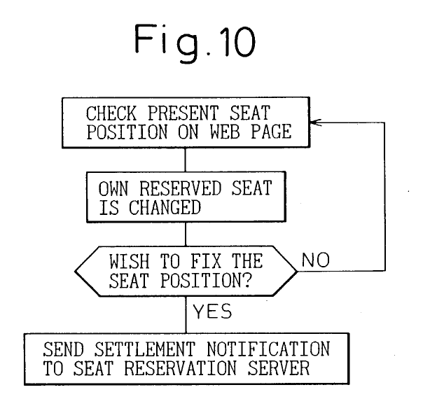

As shown in FIG. 10, the applicant can check the present seat position, that may vary according to the cancellation process by the seat reservation server described above, on a web page.

If the applicant wishes to fix his or her reserved seats to the present seat position displayed on the web page, the applicant sends a settlement notification to the seat reservation server. Upon receipt of this settlement notification, the seat reservation server fixes the final seat position for such applicant to the present seat position and stores data about settlement of the seats in the table shown in FIG. 11. Then, the seat reservation server excludes the seat reservation application with regard to the applicant who has sent the settlement notification from the object of said seat reservation cancellation process.

On the other hand, if the applicant is not satisfied by the present seat position that he or she determines from the web page, the applicant can with hold submission of the settlement notification until a cancellation occurs and his or her seat position is changed again.

When a predetermined time (for example, the day before a concert, or one hour before takeoff of an airplane) arrives, the seat reservation server terminates acceptance of seat reservations and the seat reservation cancellation process described above. Upon such termination, the seat reservation server forces the applicants' seat position to be fixed to the present position that is stored in the table shown in FIG. 11 at the time of the termination.

As described above, according to the present invention, seat reservation on a so-called “first come, first served” manner can be implemented.

Therefore, according to the present invention, a person who wishes to secure seats in a concert hall, a baseball stadium or a transport means for a concert, a baseball game or a journey can get more satisfactory seats by applying for a seat reservation earlier.

What is claimed is:

1. A method for processing seat reservation cancellations in a server that receives seat reservation applications, including numbers of seats from the first desired seat to the n-th desired seat (n is an integer not less than 2), comprising the steps of:
if any seat reservation cancellation occurs, comparing each number of seat from the first desired seat to the n-th desired seat in said seat reservation applications with the number of seat of such canceled seat sequentially in order of receipt of said seat reservation applications; and
if a number of seat of one of said reservation applications matches with the number of the cancelled seat, assigning the number of seat of said canceled seat to said one of said seat reservation applications.

2. A computer program embodying computer program instructions for allowing a server that receives seat reservation applications including numbers of seats from the first desired seat to the n-th desired seat (n is an integer not less than 2) to execute, by a computer, the steps of:
if any seat reservation cancellation occurs, comparing each number of seat from the first desired seat to the n-th desired seat in said seat reservation applications with the number of seat of such canceled seat sequentially in order of receipt of said seat reservation applications; and
if a number of seat of one of said reservation applications matches with the number of the cancelled seat, assigning the number of seat of said canceled seat to said one of said seat reservation applications.

3. A method for processing seat reservation cancellations in a server that receives seat reservation applications including numbers of areas in which seats are disposed from the first desired area to the n-th desired area (n is an integer not less than 2), comprising the step of:
if any seat reservation cancellation occurs, comparing each number of seat of a plurality of seats disposed in each area from the first desired area to the n-th desired area in said seat reservation applications with the number of seat of such canceled seat sequentially in order of receipt of said seat reservation application; and
if a number of seat of one of said reservation applications matches with the number of the cancelled seat, assigning the number of seat of said canceled seat to said one of said seat reservation applications.

4. A computer program embodying computer program instructions for allowing a server that receives seat reservation applications including numbers of areas in which seats are disposed from the first desired area to the n-th desired area (n is an integer not less than 2) to execute, by a computer, the steps of:
if any seat reservation cancellation occurs, comparing each number of seat of a plurality of seats disposed in each area from the first desired area to the n-th desired area in said seat reservation applications with the number of seat of said canceled seat sequentially in order of receipt of said seat reservation application; and
if a number of seat of one of said reservation applications matches with the number of said cancelled seat, assigning the number of seat of said canceled seat to said one of said seat reservation applications.

5. A method for seat reservation comprising the steps of:
receiving, by a server, seat reservation applications including numbers of seats from the first desired seat to the n-th desired seat (n is an integer not less than 2) that are sent by a user from a terminal via a network;
comparing, by the server, each number of seat from the first desired seat to the n-th desired seat in said seat reservation applications with the number of seat of an unoccupied seat sequentially in order of receipt of said seat reservation applications;
if the number of seat of one of said seat reservation applications matches with the number of seat of said unoccupied seat, assigning the number of seat of said unoccupied seat to said one of said seat reservation applications;
if any seat reservation cancellation occurs, for the first desired seat in said seat reservation applications, comparing, by said server, the number of seat of said desired seat with the number of seat of the canceled seat sequentially in order of receipt of said seat reservation applications;
if the number of seat of one of said seat reservation applications matches with the number of said cancelled seat, performing a cancellation process to assign the number of seat of said canceled seat to said one of said seat reservation applications; and
if the number of seat of any one of said seat reservation applications does not match with the number of said cancelled seat, repeating said cancellation process for the second to n-th desired seats.

6. A computer program embodying computer program instructions for allowing a server that accepts seat reservations to execute, by a computer, the steps of:
receiving seat reservation applications including numbers of seats from the first desired seat to the n-th desired seat (n is an integer not less than 2) that are sent by a user from a terminal via a network;
comparing each number of seat from the first desired seat to the n-th desired seat in said seat reservation application with the number of seat of an unoccupied seat sequentially in order of receipt of said seat reservation applications;
if the number of seat of one of said seat reservation applications matches with the number of seat of said unoccupied seat, assigning the number of seat of said unoccupied seat to said one of said seat reservation applications;
if any seat reservation cancellation occurs, for the first desired seat in said seat reservation applications, comparing the number of seat of said desired seat with the number of seat of the canceled seat sequentially in order of receipt of said seat reservation applications;
if the number of seat of one of said seat reservation applications matches with the number of said cancelled seat, performing a cancellation process to assign the number of seat of said canceled seat to said one of said seat reservation applications; and
if the number of seat of anyone of said seat reservation applications does not match with the number of said cancelled seat, repeating said cancellation process for the second to n-th desired seats.

7. A method for seat reservations comprising the steps of:
receiving, by a server, seat reservation applications including numbers of seats from the first desired seat to the n-th desired seat (n is an integer not less than 2) that are sent by a user from a terminal via a network;
storing, by the server, said seat reservation applications that are received sequentially in a queue sequentially from the top of the queue;
comparing, by the server, each number of seat from the first desired seat to the n-th desired seat in said seat reservation applications with the number of seat of an unoccupied seat sequentially in order of receipt of said seat reservation applications;
if the number of seat of one of said seat reservation applications matches with the number of seat of said unoccupied seat, assigning the numbers of seat of said unoccupied seat to said one of said seat reservation applications;
if any seat reservation cancellation occurs, for the first desired seat in said seat reservation applications, comparing, by the server, the number of seat of said desired seat with the number of seat of the canceled seat sequentially from the seat reservation application that is stored at the top of the queue;
if the number of seat of one of said seat reservation applications matches with the number of seat of said cancelled seat, performing a cancellation process to assign the number of seat of said canceled seat to said one of said seat reservation applications and store the seat reservation application to which such number of seat is assigned at the bottom of the queue; and
if any number of seat of said seat reservation applications does not match with the number of seat of said cancelled seat, repeating said cancellation process for the second to n-th desired seats.

8. A computer program embodying computer program instructions for allowing a server that accepts seat reservations to execute, by a computer, the steps of:
receiving seat reservation applications including numbers of seats from the first desired seat to the n-th desired seat (n is an integer not less than 2) that are sent by a user from a terminal via a network;
storing said seat reservation applications that are received sequentially in a queue sequentially from the top of the queue;
comparing each number of seat from the first desired seat to the n-th desired seat in said seat reservation application with the number of seat of an unoccupied seat sequentially in order of receipt of said seat reservation applications;
if the number of seat of one of said seat reservation applications matches with the number of seat of said unoccupied seat, assigning the numbers of seat of said unoccupied seat to the seat reservation application when;
if any seat reservation cancellation occurs, for the first desired seat in said seat reservation applications, comparing the number of seat of said desired seat with the number of seat of the canceled seat sequentially from seat reservation application that is stored at the top of the queue;
if the number of seat of one of said seat reservation application matches with the number of seat of said cancelled seat, performing a cancellation process to assign the number of seat of said canceled seat to said one of said seat reservation applications and store the seat reservation application to which such number of seat is assigned at the bottom of the queue; and
if any number of seat of said seat reservation applications does not match with the number of seat of said cancelled seat, repeating said cancellation process for the second to n-th desired seats.

9. A method for seat reservations comprising the steps of:
receiving, by the server, seat reservation applications including numbers of areas in which seats are disposed from the first desired area to the n-th desired area (n is an integer not less than 2) that are sent by a user from a terminal via a network;
comparing, by the server, each number of seat of a plurality of seats disposed in each area from the first desired area to the n-th desired area in said seat reservation application with the number of seat of an unoccupied seat sequentially in order of receipt of said seat reservation applications;
if the number of seat of one of said seat reservation applications matches with the number of seat of said unoccupied seat, assigning the number of seat of said unoccupied seat to said one of said seat reservation applications;
if any seat reservation cancellation occurs, for the first desired area in said seat reservation application, comparing, by the server, each number of seat of the plurality of seats disposed in said desired area with the number of seat of the canceled seat sequentially in order of receipt of said seat reservation applications;
if the number of seat of one of said seat reservation applications matches with the number of seat of said cancelled seat, performing a cancellation process to assign the number of seat of said canceled seat to said one of said seat reservation applications; and
if any number of seat of said seat reservation applications does not match with the number of seat of said cancelled seat, repeating said cancellation process for the second to n-th desired seats.

10. A computer program embodying computer program instructions for allowing a server that accepts seat reservations to execute, by a computer, the steps of:
receiving seat reservation applications including numbers of areas in which seats are disposed from the first desired area to the n-th desired area (n is an integer not less than 2) that are sent by a user from a terminal via a network;
comparing each number of seat of a plurality of seats disposed in each area from the first desired area to the n-th desired area in said seat reservation application with the number of seat of an unoccupied seat sequentially in order of receipt of said seat reservation application;
if the number of seat of one of said seat reservation applications matches with the number of seat of said unoccupied seat, assigning the number of seat of said unoccupied seat to said one of said seat reservation applications;
if any seat reservation cancellation occurs, for the first desired area in said seat reservation application, comparing each number of seat of the plurality of seats disposed in said desired area with the number of seat of the canceled seat sequentially in order of receipt of said seat reservation applications; if the number of seat of one of said seat reservation applications matches with the number of seat of said cancelled seat, performing a cancellation process to assign the number of seat of said canceled seat to said one of said seat reservation applications; and
if any number of seat of said seat reservation applications does not match with the number of seat of said cancelled seat, repeating said cancellation process for the second to n-th desired seats.

11. A method for seat reservations comprising the steps of:
receiving, by a server, seat reservation applications including numbers of areas in which seats are disposed from the first desired area to the n-th desired area (n is an integer not less than 2) that are sent by a user from a terminal via a network;
storing, by the server, said seat reservation applications that are received sequentially in a queue sequentially from the top of the queue;
comparing, by the server, each number of seat of a plurality of seats disposed in each area from the first desired area to the n-th desired area in said seat reservation application with the number of seat of an unoccupied seat sequentially in order of receipt of said seat reservation applications;
if the number of seat of one of said seat reservation applications matches with the number of seat of said unoccupied seat, assigning, by the server, the number of seat of said unoccupied seat to said one of said seat reservation applications;
if any seat reservation cancellation occurs, for the first desired seat in said seat reservation applications, comparing, by the server, each number of seat of the plurality of seats disposed in said desired area with the number of seat of the canceled seat sequentially from seat reservation application that is stored at the top of the queue;
if the number of seat of one of said seat reservation applications matches with the number of seat of said cancelled seat, performing a cancellation process to assign the number of seat of said canceled seat to said one of said seat reservation application and store the seat reservation application to which said number of seat is assigned at the bottom of the queue; and
if any number of seat of said seat reservation application does not match with the number of seat of said cancelled seat, repeating said cancellation process for the second to the n-th desired areas.

12. A computer program embodying computer program instructions for allowing a server that accepts seat reservations to execute by a computer, the steps of:
receiving seat reservation applications including numbers of areas in which seats are disposed from the first desired area to the n-th desired area (n is an integer not less than 2) that are sent by a user from a terminal via a network;
storing said seat reservation applications that are received sequentially in a queue sequentially from the top of the queue;
comparing each number of seat of a plurality of seats disposed in each area from the first desired area to the n-th desired area in said seat reservation application with the number of seat of an unoccupied seat sequentially in order of receipt of said seat reservation application;
if the number of seat of one of said seat reservation applications matches with the number of seat of said unoccupied seat, assigning the number of seat of said unoccupied seat to said one of said seat reservation applications;
if any seat reservation cancellation occurs, for the first desired seat in said seat reservation applications, comparing each number of seat of the plurality of seats disposed in said desired area with the number of seat of the canceled seat sequentially from seat reservation application that is stored at the top of the queue;
if the number of seat of said seat reservation applications matches with the number of seat of said cancelled seat, performing a cancellation process to assign the number of seat of said canceled seat to said one of said seat reservation application and store the seat reservation application to which said number of seat is assigned at the bottom of the queue; and
if any number of seat of said seat reservation applications does not match with the number of seat of said cancelled seat, repeating said cancellation process for the second to the n-th desired areas.
